(19) United States
(12) Patent Application Publication
(10) Pub. No.: US 2026/0367401 A1
(43) Pub. Date: Nov. 19, 2026

(54) OPTICAL SYSTEM FOR AN AUGMENTED REALITY DISPLAY

(71) Applicant: AlphaLum SA, Lausanne (CH)

(72) Inventors: Eric TREMBLAY, Lausanne (CH); Carlos MACIAS, Pully (CH)

(21) Appl. No.: 19/137,657

(22) PCT Filed: Nov. 17, 2023
(86) PCT No.: PCT/EP2023/082233

§ 371 Date: Jun. 11, 2025

(30) Foreign Application Priority Data
Dec. 16, 2022 (DE) 10 2022 133 568.2

(51) Int. Cl. G02B 27/01; G02B 5/30

(52) U.S. Cl. CPC G02B 27/0172; G02B 5/3083; G02B 27/0103; G02B 2027/0109; G02B 2027/013; G02B 2027/0174; G02B 2027/0178

(57) ABSTRACT

According to embodiments, an optical system comprises an image generator configured to generate image light, a reflective pancake optical combiner located within a field of view of a user of the optical system and arranged between the user and a scene located in front of the reflective pancake optical combiner, an optical spreader arranged between the image generator and the reflective pancake optical combiner on a side facing the user, the optical spreader being configured to spread the image light so as to form spread image light, wherein the reflective pancake optical combiner is configured to reflect the spread image light as collimated light towards the user, and an optical deflector arranged between the scene and the reflective pancake optical combiner, the optical deflector being configured to deflect leaked image light from the optical system in a direction different from a central axis of the optical system.

### CROSS-REFERENCE TO RELATED APPLICATIONS

This application is a national phase of International Application No. PCT/EP2023/082233 filed on Nov. 17, 2023, which claims priority to German patent application DE 10 2022 133 568.2, which was filed on Dec. 16, 2022, the entire contents of both of which are incorporated herein by reference.

### TECHNICAL FIELD

Wearable augmented reality (AR) displays or near eye displays (NEDs) used in virtual and augmented reality applications allow a user to see projected content in the user's field of view whilst viewing an external environment. Such a display commonly comprises a projector secured to the side of (i.e. off-axis to) a support frame of the display. The projector projects an image onto the retina of the user wearing the display, which causes the user to see displayed content floating in space in front of them.

In greater detail, such a common display may comprise eye pieces with a holographic combiner, which is illuminated by the projector. The illuminated holographic combiner causes the image to be projected through the user's pupil onto their retina.

In general, there is, however, a significant light leakage due to the display's imperfect reflection capabilities. Commonly, the display should be sufficiently transparent for ambient light to pass through. As such, when the reflector is made more transparent to the ambient light, there is more forward leakage of the leaked display light. In other words, there is a certain amount of the display light that leaks toward the vicinity, where it can be seen by other viewers.

An object of the present invention is therefore to provide an improved optical system for an AR display or an NED that is capable to handle the leaked display light more efficiently.

### SUMMARY

According to embodiments, an optical system comprises an image generator configured to generate image light, a reflective pancake optical combiner located within a field of view of a user of the optical system and arranged between the user and a scene located in front of the reflective pancake optical combiner, an optical spreader arranged between the image generator and the reflective pancake optical combiner on a side facing the user, the optical spreader being configured to spread the image light so as to form spread image light, wherein the reflective pancake optical combiner is configured to reflect the spread image light as collimated light towards the user, and an optical deflector arranged between the scene and the reflective pancake optical combiner, the optical deflector being configured to deflect leaked image light from the optical system in a direction different from a central axis of the optical system.

Specifically, the optical deflector deflects the leaked image light to directions where it can not easily viewed by others. This increases the user's privacy and prevents other people from being disturbed by the leaked image light.

The optical spreader may comprise a first volume phase hologram (VPH). The first VPH may be used to generate the spread image light, which passes the reflective pancake optical combiner and is reflected as collimated light.

In addition, the optical deflector may comprise a second VPH.

In this context, the first VPH and the second VPH may each be recorded using the same recording system. Using the same setup ensures good alignment and diffraction efficiency and eliminates the need for a separate component manufacturing line. That is, the first VPH and the second VPH may share the manufacturing lines. This may ensure correct geometry, tolerances and efficiency as compared to a completely separately specified element used to capture the leaked image light.

The second VPH may be configured to focus the leaked light to a point in the direction different from the central axis.

The second VPH may also be configured to collimate the leaked light in the direction different from the central axis.

Furthermore, the second VPH may be configured to diverge the leaked light in the direction different from the central axis.

According to embodiments, the optical deflector may further comprise an optical waveguide configured to guide the leaked image light to a light-decoupling end of the optical waveguide. For example, the optical deflector may further be configured to couple the leaked image light into the optical waveguide.

The leaked image light may correspond to the spread image light exiting the reflective pancake optical combiner at a front side of the reflective pancake optical combiner. The optical deflector may thus be arranged at a central portion of the reflective pancake optical combiner to efficiently deflect this axial leaked image light.

However, the leaked image light may also correspond to the image light which passes through the optical spreader without being spread. In this case, the optical deflector may be arranged at a peripheral portion of the reflective pancake optical combiner to defect the leaked image light.

In this regard, the optical system may further comprise a beam capture element configured to absorb the deflected leaked image light.

Moreover, the optical deflector may comprise a dielectric mirror. The use of such an element may alleviate the need of the beam capture element.

In addition, the reflective pancake optical combiner may be configured to transmit ambient light without aberration of the ambient light.

In greater detail, the reflective pancake optical combiner may comprise a polarization-dependent reflector, an optically-powered reflector, and a retarder arranged between the polarization-dependent reflector and the optically-powered reflector.

The optical spreader may be configured to selectively spread the image light incident on the optical spreader.

The optical spreader may be located within or forms part of, the reflective pancake optical combiner.

According to embodiments, a wearable augmented reality (AR) display comprises the optical system as described above, and a support frame for mounting the optical system onto a head of the user so that the reflective pancake optical combiner is positioned in a field of view of the user.

According to embodiments, a near eye display (NED) comprises an optical deflector including a volume phase hologram (VPH) configured to deflect leaked image light from the NED in a direction different from a central axis of the NED display.

Similar effects are achieved by the NED display as described above with regard to the optical system in the AR display.

### BRIEF DESCRIPTION OF THE DRAWINGS

The accompanying drawings are included to provide a further understanding of embodiments of the invention and are incorporated in and constitute a part of this specification. The drawings illustrate the embodiments of the present invention and together with the description serve to explain the principles. Other embodiments of the invention and many of the intended advantages will be readily appreciated, as they become better understood by reference to the following detailed description. The elements of the drawings are not necessarily to scale relative to each other. Like reference numbers designate corresponding similar parts.

FIG. 1 is a schematic diagram illustrating an wearable augmented reality (AR) display according to embodiments.

FIG. 2 is a schematic diagram illustrating an optical system for the AR display according to embodiments.

FIG. 3 is a schematic diagram illustrating an optical spreader according to embodiments.

FIG. 4A is a schematic diagram illustrating an optical deflector according to embodiments.

FIG. 4B is a schematic diagram illustrating the optical system applying the optical deflector of FIG. 4A.

FIG. 5A is a schematic diagram illustrating an optical deflector according to embodiments.

FIG. 5B is a schematic diagram illustrating the optical system applying the optical deflector of FIG. 5A.

FIG. 6A is a schematic diagram illustrating an optical deflector according to embodiments.

FIG. 6B is a schematic diagram illustrating the optical system applying the optical deflector of FIG. 6A.

FIG. 7 is a schematic diagram illustrating an optical system for the AR display according to embodiments.

FIG. 8A is a schematic diagram illustrating an optical deflector according to embodiments.

FIG. 8B is a schematic diagram illustrating the optical system applying the optical deflector of FIG. 8A.

FIG. 9 is a schematic diagram illustrating the AR display applying the optical system of FIG. 8B.

### DETAILED DESCRIPTION

In the following detailed description reference is made to the accompanying drawings, which form a part hereof and in which are illustrated by way of illustration specific embodiments in which the invention may be practiced. In this regard, directional terminology such as “top”, “bottom”, “front”, “back”, “over”, “on”, “above”, “leading”, “trailing” etc. is used with reference to the orientation of the Figures being described. Since components of embodiments of the invention can be positioned in a number of different orientations, the directional terminology is used for purposes of illustration and is in no way limiting. It is to be understood that other embodiments may be utilized and structural or logical changes may be made without departing from the scope defined by the claims.

The description of the embodiments is not limiting. In particular, elements of the embodiments described hereinafter may be combined with elements of different embodiments.

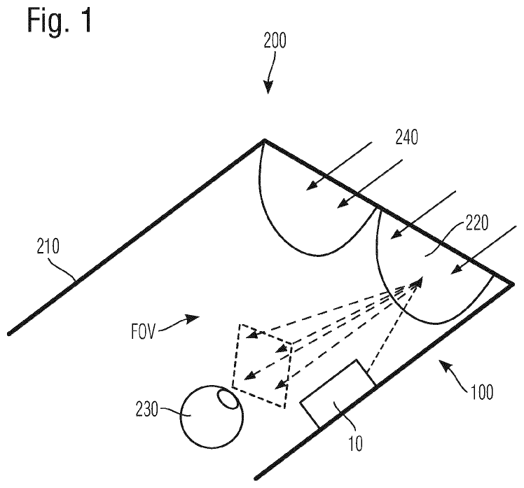

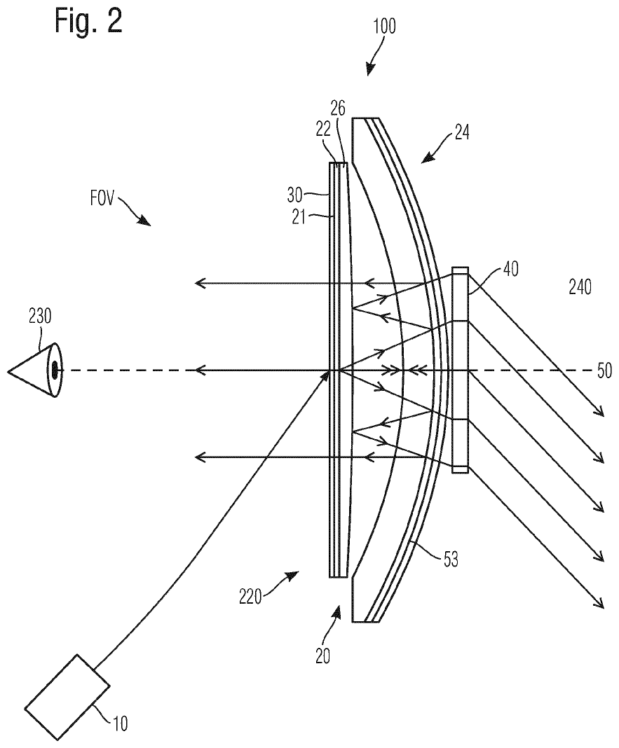

FIG. 1 is a schematic diagram illustrating an wearable augmented reality (AR) display 200 according to embodiments. The AR display 200 comprises a support frame 210 and an optical system 100 mounted thereon. The optical system 100 comprises an image generator 10 that may be configured as a laser projector projecting image light including one or more wavelengths (e.g., red light, green light, or blue light). In addition, the optical system 100 comprises a reflective pancake optical combiner 20, an optical spreader 30, and an optical deflector 40 (not shown in FIG. 1), which will be explained in detail with reference to FIG. 2. These elements 20, 30, 40 are represented collectively as an eyepiece 220 in FIG. 1.

When the AR display 200 is in use, the support frame 210 is mounted on the head of a user and the eyepiece 220 is positioned in a field of view FOV of the user. Ambient light from a scene 240 in front of the AR display 200 may be transmitted by the eyepiece 220 towards an eye 230 of the user, in addition to the reflected image light. This is indicated by respective arrows in FIG. 1. In greater detail, the eyepiece 220 may reproduce an image defined by the projected image light in a vicinity of the eye 230 illustrated in a simplified manner by the dashed frame in FIG. 1.

In general, there exists an amount of image light that is not projected to the user and leaks through the AR display 200 when in use (so-called forward leakage). This leaked image light is undesirable for privacy reasons of the user. Furthermore, it is also annoying to other people who are close to the user wearing the AR display 200.

This problem is addressed by the optical system 100 of the present invention, which is described in detail in the following with reference to FIG. 2.

FIG. 2 is a schematic diagram illustrating the optical system 100 for the AR display 200 according to embodiments.

The optical system 100 comprises the image generator 10 that generates the image light. It further includes the reflective pancake optical combiner 20 located within the field of view FOV of the user. In detail, the reflective pancake optical combiner 20 is arranged between the user and the scene 240 located in front of the reflective pancake optical combiner 20.

The reflective pancake optical combiner 20 may further comprise a polarization-dependent reflector 22, an optically-powered reflector 24, and a retarder 26 arranged between the polarization-dependent reflector 22 and the optically-powered reflector 24.

The optically-powered reflector 24 may comprise a curved transparent body or substrate having a dichroic reflective coating disposed on a front convex surface thereof. The dichroic reflective coating may be highly reflecting in one or more narrow spectral bands. For example, the narrow spectral bands may be arranged around a corresponding wavelength of the image light. Furthermore, the reflective coating may reflect ambient light at wavelengths inside the one or more narrow spectral bands and may transmit ambient light at wavelengths outside the one or more narrow spectral bands.

The polarisation-dependent reflector 22 and the dichroic reflective coating of the optically-powered reflector 24 may form an optical cavity in which the retarder 56 may be located. Moreover, the polarisation-dependent reflector 22 and the optically-powered reflector 24 may be arranged so that the polarisation-dependent reflector 22 is located in an optical path between the first VPH and the optically-powered reflector 24.

The retarder 26 may convert circularly-polarised ambient light transmitted by the dichroic reflective coating to linearly-polarised ambient light having a linear polarization.

In use, the reflective pancake optical combiner 20 comprising the above described elements 22, 24, 26 may effectively combine the ambient light incident on the front side 21 with the collimated light exiting on the rear side 23.

Furthermore, the optical spreader 30 is arranged between the image generator 10 and the reflective pancake optical combiner 20 on a side facing the user. The optical spreader 30 spreads the image light so as to form spread image light. As illustrated in FIG. 2, a light beam from the image projector 10 is fanned out into additional linearly polarized light beams traversing the reflective pancake optical combiner 20 until they are reflected as collimated light towards the user. This is illustrated by corresponding arrows in FIG. 2. Through this arrangement the image may be reproduced in the vicinity of the eye 230 of the user as described in relation with FIG. 1

Specifically, the optical system 100 comprises the optical deflector 40 arranged between the scene 240 and the reflective pancake optical combiner 20. As can be seen in FIG. 2, the optical deflector 40 deflects the leaked image light in a direction different from a central axis 50 of the optical system 100. That is, the optical deflector 40 enables the leaked image light to be deflected in such a way that it is not be perceived by another user who is in the vicinity of the AR display 200. The optical deflector shown in FIG. 2 has a planar form. But different forms are possible, for example, a curved form.

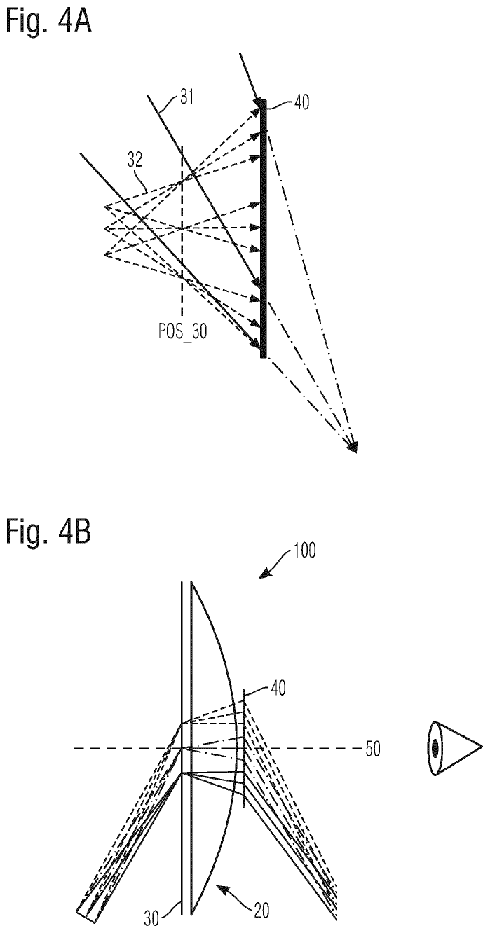

The leaked image light illustrated in FIG. 2 is reflected in a downward direction, away from the central axis 50. However, different deflection directions may be possible. For example, an upward direction, a right direction, or a left direction may be realized via the optical deflector 40. Further configurations for the optical deflector 40 are described below with reference to FIGS. 4A, 5A, and 6A.

In greater detail, the optical spreader 30 may comprise a first volume phase hologram (VPH). In general, a VPH is a diffractive element including a periodic phase or absorption perturbation throughout the entire volume of the element. The periodic phase or absorption perturbation corresponds to a specific recorded interference pattern referred to as a volume holographic grating. When a beam of incident light satisfies the Bragg phase matching condition, it is diffracted by the periodic perturbation. That is, incident light beams are diffracted by the VPH only at a particular angle, so that a high diffraction efficiency can be achieved. Due to the limited range of wavelengths and angles over which diffraction occurs, it is possible to have multiple gratings inside the same volume that work independently and without interfering with each other. For example, if two gratings are recorded in the same volume for two different Bragg wavelengths at the same incidence angle, the volume can diffract the two selected wavelengths into different output directions with limited crosstalk. Recording multiple gratings into one volume is also known as multiplexing.

Specifically, there exist two types of VPHs known as transmission VPHs and reflection VPHs. The transmission and reflection VPHs are discerned depending on their recording geometry. If incident and diffracted beams are located on the same side of the recording material, the hologram is known as reflective. When the incident and diffracted beams are found on opposite sides of the hologram, then the hologram is transmissive. Whether reflective or transmissive, an VPH is fabricated by recording an interference pattern in a plate of holographic material.

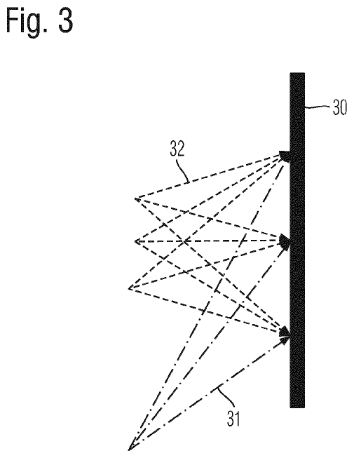

In this context, a recording geometry of the first VPH of the optical spreader 30 is shown in FIG. 3. As can be seen in FIG. 3, object beams 32 and reference beams 31 are used to record the first VPH, which may be formed as a transmissive VPH. The first VPH may be multiplexed and may comprise an interference pattern that spreads the incident image light.

In greater detail, the first VPH may selectively spread or fan-out the incident image light at higher angles of incidence. It may also be configured to transmit the ambient light from the scene 240 without spreading, scattering, or fanning it out.

For example, as shown in FIG. 2 and described above, the first VPH may spread/fan-out, or separate the image light into three different directions illustrated by the three different light beams. Each light beam of the spread image light propagates the reflective pancake optical combiner 20. The light beams are then at least partly reflected and incident on a rear side 21 of the reflective pancake optical combiner 20 as collimated light.

In this context, the leaked image light, e.g., the part of the spread image light that is not reflected, may be incident to the optical deflector 40, which redirects the light away from the central axis 50.

The optical deflector 40 may comprise a second VPH. The second VPH may have a recording geometry as shown in FIGS. 4A, 5A, and 6A.

In detail, the first VPH and the second VPH may each be recorded using the same recording system. That is, it is possible to use the same recording setup used for the first VPH to create the second VPH. Using the same setup may ensure a good alignment and diffraction efficiency and eliminates the need for a separate component manufacturing line. More specifically, the second VPH may be recorded with correct angles and wavelengths to properly capture the leaked image light and diffract it.

In this regard, the second VPH may be configured to focus the leaked light to a point in the direction different from the central axis 50. A recording geometry for such a VPH is illustrated in FIG. 4A. The long dashed line illustrates the position POS 30 of the first VPH. As can be seen, the second VPH is recorded via the object beams 32 and the reference beams 31 forming a specific interference pattern captured in a plate of holographic material. The diffracted beams, indicated by dashed arrows in FIG. 4A, converge to a single point on the side opposite the incident leaked image light. Thus, the second VP may be a transmissive VPH. The resulting deflection of the leaked image light is shown in FIG. 4B, where the reflective pancake optical combiner 20 is illustrated in a simplified manner.

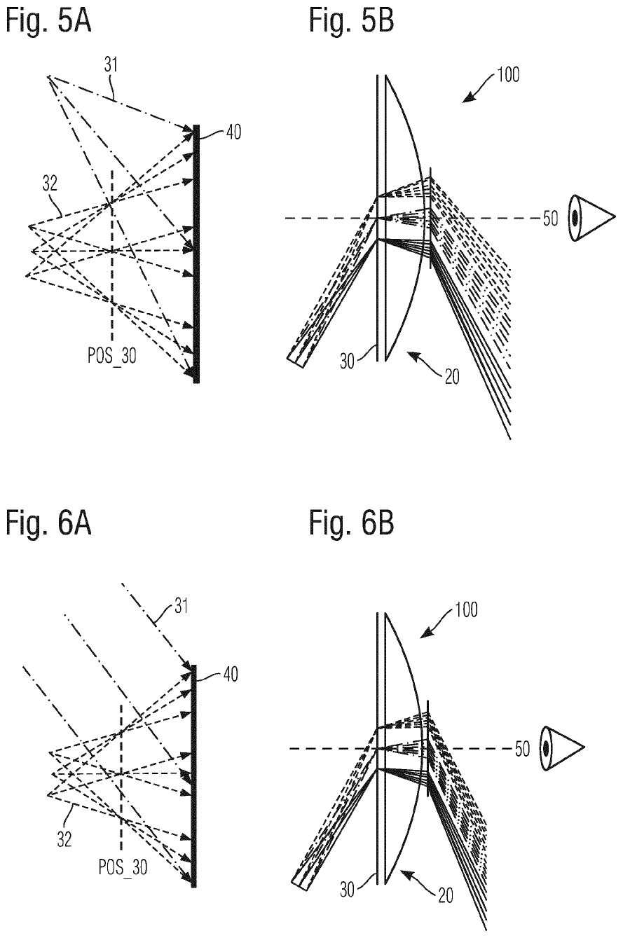

According to yet further embodiments, the second VPH may be configured to diverge the leaked light in the direction different from the central axis 50. A recording geometry for the second VPH and the resulting deflection for this case is schematically shown in FIGS. 5A and 5B.

According to further embodiments, the second VPH may also be configured to collimate the leaked light in the direction different from the central axis 50. A recording geometry for the second VPH and the resulting deflection is schematically shown in FIGS. 6A and 6B.

It is noted that different recording geometries may be used for the first and second VPH. Furthermore, the second VPHs shown in FIGS. 4A, 5A, and 6A are shown as transmission VPHs. But they may also be configured as reflective VPHs. An embodiment applying a reflective VPH as the second VPH will be explained in detail with reference to FIG. 9 later on.

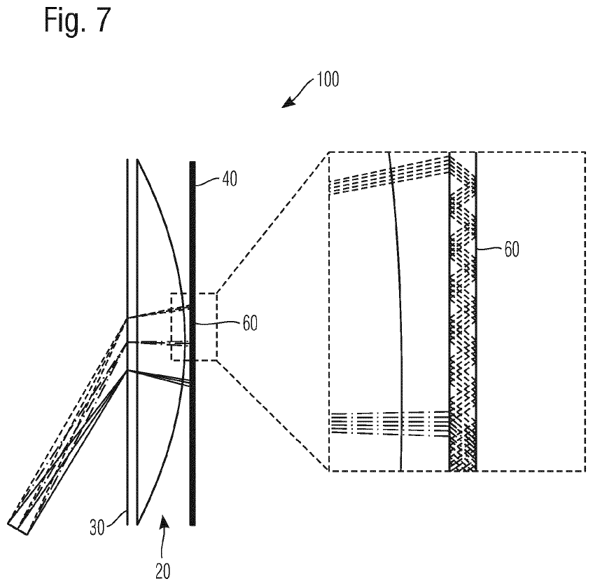

According to further embodiments, the optical deflector 40 may comprise an optical waveguide 60 configured to guide the leaked image light to a light-decoupling end of the optical waveguide 60. This is illustrated in FIG. 7, which shows a simplified schematic view of the optical system 100 including the reflective pancake optical combiner 20, the optical spreader 30, the optical deflector 40, and the waveguide 60. The waveguide 60 is shown in more detail in the enlarged portion on the right side of FIG. 7. As can be seen, the optical waveguide 60 may be disposed on, and attached to the optical deflector 40, which couples the leaked image light into it. The leaked image light may then be guided towards the end of the optical waveguide 60 and decoupled.

As described above, the leaked image light may correspond to the spread image light exiting the reflective pancake optical combiner 20 at a front side of the reflective pancake optical combiner 53. In this case, the optical deflector 40 may be arranged at a central portion of the reflective pancake optical combiner 20 to efficiently deflect the leaked image light as shown in FIGS. 2, 3B, 4B, 5B, and 6B.

According to further embodiments, the leaked image light may also correspond to the image light which passes through the optical spreader 30 without being spread. Besides the main axial leaked image light described above, there may be a second source of leaked image light. That is, there may be leaked image light from the image projector 10, which is not diffracted at all by the first VPH of the optical spreader 30 and not reflected from the reflective pancake optical combiner 20. In this case, the optical deflector 40 may be arranged at a peripheral portion of the reflective pancake optical combiner 20 to capture the leaked image light.

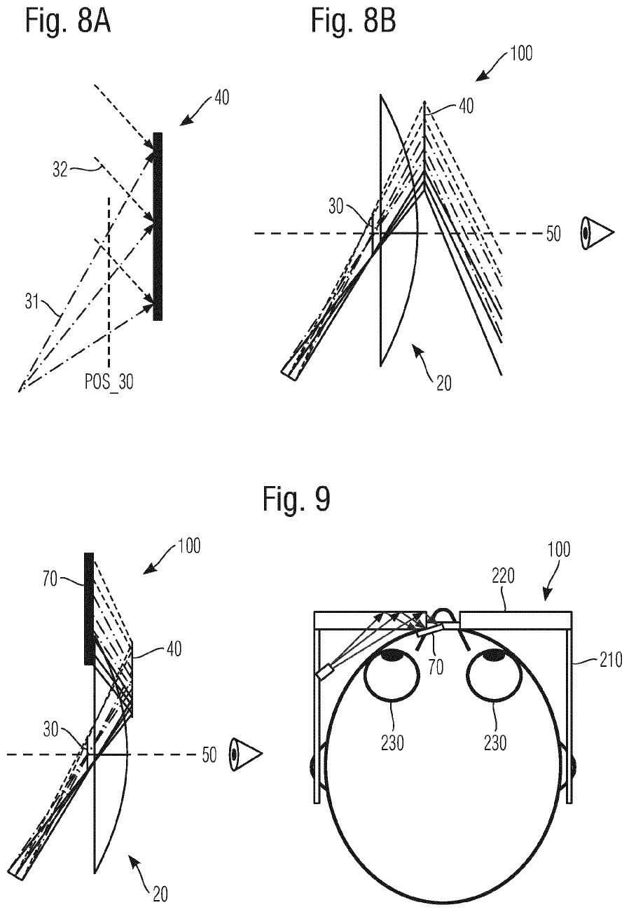

Such a configuration is illustrated in FIGS. 8A and 8B, where FIG. 8A shows a corresponding recording geometry for the second VPH. In this case, the second VPH may only be multiplexed with light beams corresponding to the wavelengths for red light, green light and blue light, and may therefore be more easily configured either as a transmissive VPH, which is shown in FIGS. 8A and 8B, or a reflective VPH, which is shown in FIG. 9. As can be seen in FIG. 8B, the leaked image light is deflected from the Central axis 50.

The optical system 10 may further comprise a beam capture element 70 configured to absorb the deflected leaked image light, which is indicated in FIG. 9. In this case, the leaked image light deflected by the (reflective) second VPH may be captured by the beam capture element 70 arranged on the support frame 210.

In this regard, the optical deflector 40 may comprise a dielectric mirror. For example, a thin film dielectric mirror may be used, since the deflected leaked light beams may then not need to be diffracted to steer them to the beam capture element 70.

According to embodiments, the reflective pancake optical combiner 20 may transmit ambient light without aberration of the ambient light. For example, all of the optical elements in the path of the ambient light may have zero optical power when re-fracted through—i.e. either a flat glass or curved glass with similar curvatures on both sides. Thereby, the ambient light may be transmitted without aberration,

According to further embodiments, the reflective pancake optical combiner 20 may further comprise the polarization-dependent reflector 22, the optically-powered reflector 24, and the retarder 26 arranged between the polarization-dependent reflector 22 and the optically-powered reflector 24 as described

In this context, the optical spreader may selectively spread the image light incident on the optical spreader 30.

In greater detail, the optical spreader 30 may be located within or forms part of, the reflective pancake optical combiner 20.

According to embodiments, a wearable AR 200 display comprises the optical system 10 as explained above, and a support frame 210 for mounting the optical system 100 on the head of the user so that the reflective pancake optical combiner 20 is positioned in the field of view FOV of the user.

According to embodiments, a near NED comprises an optical deflector 40 as described above, which includes the second VPH configured to deflect leaked image light from the NED in a direction different from a central axis of the NED display.

While embodiments of the invention have been described above, it is obvious that further embodiments may be implemented. For example, further embodiments may comprise any subcombination of features recited in the claims or any sub-combination of elements described in the examples given above. Accordingly, this spirit and scope of the appended claims should not be limited to the description of the embodiments contained herein.

### LIST OF REFERENCES

10 Image Generator
20 reflective pancake optical combiner
21 rear side of the reflective pancake optical combiner
22 polarization-dependent reflector
23 front side of the reflective pancake optical combiner
24 optically-powered reflector
26 retarder
30 optical spreader
40 optical deflector
50 central axis
60 optical waveguide
70 beam capture element
VPH first/second volume phase hologram
100 optical system
FOV field of view
200 AR display
210 support frame
220 eyepiece
230 eye of user
240 scene
POS_30 position of first volume phase hologram

1. An optical system comprising:
an image generator configured to generate image light;
a reflective pancake optical combiner located within a field of view (FOV) of a user of the optical system and arranged between the user and a scene located in front of the reflective pancake optical combiner;
an optical spreader arranged between the image generator and the reflective pancake optical combiner on a side facing the user, the optical spreader being configured to spread the image light so as to form spread image light, wherein the reflective pancake optical combiner is configured to reflect the spread image light as collimated light towards the user; and
an optical deflector arranged between the scene and the reflective pancake optical combiner, the optical deflector being configured to deflect leaked image light from the optical system in a direction different from a central axis of the optical system.

2. The optical system according to claim 1, wherein the optical spreader comprises a first volume phase hologram, VPH.

3. The optical system according to claim 2, wherein the optical deflector comprises a second VPH.

4. The optical system according to claim 3, wherein the first VPH and the second VPH each are recorded using the same recording system.

5. The optical system according to claims wherein the second VPH is configured to focus the leaked light to a point in the direction different from the central axis.

6. The optical system according to claim 3, wherein the second VPH is configured to collimate the leaked light in the direction different from the central axis.

7. The optical system according to claim 3, wherein the second VPH is configured to diverge the leaked light in the direction different from the central axis.

8. The optical system according to claim 1, wherein the optical deflector further comprises an optical waveguide configured to guide the leaked image light to a light-decoupling end of the optical waveguide, wherein the optical deflector is further configured to couple the leaked image light into the optical waveguide.

9. The optical system according to claim 1, wherein the leaked image light corresponds to the spread image light exiting the reflective pancake optical combiner at a front side of the reflective pancake optical combiner, and wherein the optical deflector is arranged at a central portion of the reflective pancake optical combiner.

10. The optical system according to claim 1, wherein the leaked image light corresponds to the image light which passes through the optical spreader without being spread, and wherein the optical deflector is arranged at a peripheral portion of the reflective pancake optical combiner.

11. The optical system according to claim 10, wherein the optical system further comprises a beam capture element configured to absorb the deflected leaked image light.

12. The optical system according to claim 10, wherein the optical deflector comprises a dielectric mirror.

13. The optical system according to claim 1, wherein the reflective pancake optical combiner is configured to transmit ambient light without aberration of the ambient light.

14. The optical system according to claim 1, wherein the reflective pancake optical combiner comprises:
a polarization-dependent reflector;
an optically-powered reflector; and
a retarder arranged between the polarization-dependent reflector and the optically-powered reflector.

15. The optical system according to claim 1, wherein the optical spreader is configured to selectively spread the image light incident on the optical spreader.

16. The optical system according to claim 1, wherein the optical spreader is located within or forms part of, the reflective pancake optical combiner.

17. A wearable augmented reality, AR, display comprising:
the optical system of claim 1; and
a support frame for mounting the optical system on the user so that the reflective pancake optical combiner is positioned in a field of view of the user.

18. A near eye display, NED, comprising:
an optical deflector including a volume phase hologram, VPH, configured to deflect leaked image light from the NED in a direction different from a central axis of the NED display.
